(19) United States
(12) Patent Application Publication
(10) Pub. No.: US 2026/0179925 A1
(43) Pub. Date: Jun. 25, 2026

(54) METHODS AND SYSTEMS FOR MANUFACTURING CATHODE ACTIVE MATERIALS FOR RECHARGEABLE BATTERIES

(71) Applicant: NASCENT MATERIALS INC., Short Hills, NJ (US)

(72) Inventors: Nicholas Grundish, Austin, TX (US); Mayank Sharma, Austin, TX (US); Chaitanya Sharma, Short Hills, NJ (US)

(21) Appl. No.: 19/414,594

(22) Filed: Dec. 10, 2025

Related U.S. Application Data
(60) Provisional application No. 63/738,547, filed on Dec. 24, 2024.

(51) Int. Cl. H01M 4/36; H01M 4/505; H01M 4/525; H01M 4/58

(52) U.S. Cl. CPC H01M 4/366; H01M 4/505; H01M 4/525; H01M 4/5825

(57) ABSTRACT

The present disclosure provides methods and system for manufacturing cathode active materials for rechargeable batteries. The method includes melting precursor materials (10, 10a) to form a molten mixture (12, 12a), which is either solidified into a dense ingot for nanoshearing (14) or directly atomized (14a) into fine droplets that solidify into particles of controlled dimensions, which may include micro- or nanoscale or combinations thereof. The resulting particles of controlled dimensions are subsequently directed to a coating step (16, 16a), where conductive or protective layers are applied to enhance electrochemical performance, thereby yielding cathode active materials (18, 18a) with improved conductivity, stability, and energy density. The disclosed approach significantly reduces processing times, enables flexible coating options, accommodates lower-purity or processed recycled feedstocks and supports continuous manufacturing workflows. Optional post-processing, including ball milling, spray drying, thermal treatment, and chemical vapor deposition, further refines particle morphology and density of the resulting powders. The invention thus provides a scalable, efficient, and sustainable route for producing advanced cathode active materials for lithium-ion and other secondary batteries.

### TECHNICAL FIELD

The present disclosure relates to the field of rechargeable batteries and, more particularly, to methods and systems for manufacturing cathode active materials with tailored particle properties. The disclosure is directed to processes such as melt synthesis, nanoshearing, atomization, coating, and optional post-processing that enable the production of high-performance cathode materials suitable for use in including but not limited to lithium-ion batteries and phosphate-based lithium-ion batteries and related secondary battery technologies.

### BACKGROUND

Rechargeable batteries, particularly lithium-ion batteries, have become the dominant energy-storage technology for a wide range of applications, including portable electronics, electric vehicles, and stationary grid storage. The performance, safety, and cost of these batteries are strongly influenced by the properties of their electrode materials, with cathode active materials playing a central role in determining energy density, cycle life, conductivity, and stability.

Conventional methods of manufacturing cathode active materials, such as solid-state synthesis or chemical precipitation, suffer from several drawbacks. These methods typically require long processing times, often exceeding 20 to 30 hours, and involve multiple stages of high-temperature calcination and ball milling. Such approaches not only increase energy consumption and production costs but also limit throughput and scalability. Furthermore, traditional processes tend to yield powders with broad particle-size distributions and inconsistent morphologies, leading to inefficiencies in electrode fabrication and suboptimal electrochemical performance.

Another limitation of existing methods lies in their lack of flexibility in applying conductive or protective coatings. In conventional processes, coatings are often integrated into the synthesis stage itself, which restricts the variety of coatings that can be employed and limits the ability to tailor cathode powders for different chemistries and applications. Such a constraint is particularly problematic for materials such as lithium iron phosphate or lithium manganese iron phosphate, which inherently require conductive coatings, such as carbon, to achieve meaningful performance.

Additionally, current production practices in the battery industry largely rely on batch processing, where cathode powders are produced, packaged, and later consumed in slurry preparation and electrode coating steps. Such an approach introduces inefficiencies, increases handling requirements, and reduces traceability across the production chain. The growing demand for high-performance, low-cost, and sustainable batteries has driven a shift toward continuous manufacturing solutions that can provide greater efficiency, better process control, and improved material traceability.

Sustainability and resource efficiency also present pressing challenges. Traditional manufacturing routes generally depend on high-purity virgin raw materials, which increases costs and limits the ability to integrate recycled feedstocks from spent batteries. With the rapid growth of lithium-ion battery deployment, effective strategies for reusing materials from recycling streams are increasingly important to reduce environmental impacts and ensure long-term supply security.

Accordingly, there exists a need for improved methods of manufacturing cathode active materials that can reduce processing times, improve control over particle size and morphology, allow for flexible coating options, integrate with continuous manufacturing workflows, and accommodate lower-grade or recycled feedstocks. The present disclosure addresses these needs by providing innovative melt-based synthesis methods, followed by nanoshearing or atomization, which together yield precision-tailored cathode powders suitable for next-generation rechargeable batteries.

### SUMMARY

An object of the present invention is to provide an improved method for manufacturing cathode active materials for rechargeable batteries that overcomes the limitations of conventional solid-state synthesis and precipitation techniques, including long processing times, broad particle-size distributions, inconsistent particle morphology and limited coating flexibility.

Another object of the invention is to provide methods that enable rapid conversion of raw materials into cathode powders with tightly controlled particle-size distributions, uniform morphologies, and reproducible properties, thereby ensuring consistent electrochemical performance in energy-storage applications.

A further object of the invention is to provide a melt-shear process in which raw materials are melted, homogenized, and solidified into ingots that can subsequently be subjected to shear forces to produce particles of controlled dimensions, which may include micro- or nanoscale particles or combinations thereof depending on processing parameters.

A further object is to provide a melt-atomization process in which molten materials are atomized into fine droplets that rapidly solidify into powders having particle size distributions extending, for example, from sub-micron to several hundred microns. The processes are configured to minimize processing time, enable scalable operation, and facilitate integration with subsequent manufacturing or processing steps.

It is also an object of the invention to provide nanoshearing and atomization methods that afford tunable control over key process parameters, including shear forces, vortex dynamics, atomizing media, and cooling rates, enabling the tailoring of particle characteristics such as size distribution, morphology, surface area, and electrochemical activity.

Another object of the invention is to provide a method that allows coatings to be applied after particle formation, thereby providing flexibility to use a wide range of conductive or protective coatings such as carbon, oxides, or hybrid layers. Such modularity enhances conductivity, stability, and adaptability across different cathode chemistries and battery designs.

Yet another object of the invention is to enable the incorporation of lower-grade or recycled precursors, including processed black mass from lithium-ion battery recycling, in the melt-synthesis stage. The ability to utilize such materials provides a cost-effective and sustainable pathway for producing cathode active materials, while reducing dependence on high-purity virgin raw materials and supporting circular-economy practices in battery manufacturing.

A further object of the invention is to provide optional post-processing steps such as emulsion-assisted ball milling, spray drying, micro-necking thermal treatment, and chemical vapor deposition. These steps enable additional refinement of particle properties, including improved tap and compact densities, enhanced conductivity, and optimized electrochemical performance.

It is also an object of the invention to facilitate continuous, in-situ production of cathode powders that can be directly integrated into electrode slurry preparation and coating processes. Such a continuous workflow minimizes intermediate storage, reduces waste, enhances traceability, and aligns powder production with electrode fabrication, thereby improving throughput and operational efficiency.

Another object of the present disclosure is to provide modular process configurations that allow manufacturers to selectively combine nanoshearing, atomization, and post-processing steps depending on the required cathode chemistry and end-use application.

Another object of the present disclosure is to provide cathode active materials with tailored particle-size distributions, including bimodal or narrow mid-micron ranges, which are particularly advantageous for dry-electrode processing and next-generation electrode fabrication methods.

Yet another object of the present disclosure is to minimize the overall energy consumption of cathode active material production by replacing extended calcination and milling with rapid melt synthesis, nanoshearing, and atomization processes.

Another object of the present disclosure is to enable higher repeatability and reproducibility in cathode active material manufacturing by controlling process parameters such as shear angle, shear velocity, atomization media, and cooling rates.

A further object of the present disclosure is to provide a system for producing cathode active materials that incorporates dedicated modules for melting, shearing, atomization, coating, and post-processing, which may be configured as a continuous or semi-continuous production line.

Another object of the present disclosure is to broaden the range of usable feedstocks for cathode material production by accommodating lower-purity raw materials and processed recycled black mass streams, while still achieving battery-grade performance.

Another object of the present disclosure is to deliver cathode active materials with improved packing density and electrode uniformity, thereby reducing variability in electrode manufacturing and improving cell-to-cell consistency in large-scale battery packs.

Still another object of the present disclosure is to enhance manufacturing flexibility by allowing the same production line to switch between different cathode chemistries without significant downtime or retooling.

Another object of the present disclosure is to provide a scalable production platform that can be deployed in localized gigafactories, enabling decentralized manufacturing of cathode powders close to cell assembly sites.

A still further object of the invention is to provide a multifaceted, scalable, and industrially robust method for producing high-quality cathode active materials that deliver improved energy density, cycle life, conductivity, and manufacturing efficiency, thereby meeting the growing performance and sustainability demands of modern rechargeable battery technologies.

The present disclosure provides methods and systems for manufacturing cathode active materials with precision-tailored properties for use in rechargeable batteries, particularly lithium-ion batteries. The disclosed processes overcome limitations of conventional solid-state synthesis and precipitation methods by significantly reducing production time, improving control over particle size and morphology, and enabling continuous, scalable production suited to modern energy-storage demands.

In one aspect, the present disclosure provides a method of manufacturing cathode active materials for rechargeable batteries. The method includes melting precursor materials to form a molten mixture, followed by either solidifying the molten mixture into a solid ingot or directly atomizing the molten mixture into fine droplets that solidify into particles. In embodiments where a solid ingot is formed, the ingot is processed by nanoshearing, such as cyclone-based nanoshearing, to convert the bulk material into particles of controlled dimensions, which may include micro- or nanoscale or combinations thereof. In both cases, the resulting particles of controlled dimensions are subsequently subjected to a coating step in which a conductive or protective layer, such as carbon or a functional oxide, is applied. The described manufacturing approach enables the production of cathode active materials with controlled particle size distributions that are tailored for use in rechargeable batteries.

In certain embodiments, the nanoshearing is carried out in a cyclone-based unit that employs a high-velocity vortex to impart shear forces on the solid ingot, thereby breaking it down into particles of controlled dimensions, which may include micro- or nanoscale or combinations thereof with a reproducible size distribution. In other embodiments, atomization of the molten material may be carried out using any suitable atomization technique, including but not limited to water atomization, gas atomization, induction atomization, vacuum atomization, centrifugal atomization, plasma atomization, flame atomization, or other known or future-developed atomization methods. Such techniques permit control and adjustment of particle morphology and size distribution in accordance with desired material and process parameters.

The method further encompasses the flexibility to apply various conductive or protective coatings to the particles of controlled dimensions, which may include micro- or nanoscale or combinations thereof after formation. Suitable coatings include, but are not limited to, carbon, metal oxides, polymers, or hybrid layers. Such modularity in the coating process allows cathode powders to be adapted for a wide range of chemistries and performance requirements, such as enhancing conductivity or surface stability.

The precursor materials employed in the method may include lithium, transition metal, and phosphate sources suitable for the formation of lithium iron phosphate, lithium manganese iron phosphate, lithium nickel manganese cobalt oxide, lithium nickel cobalt aluminum oxide, lithium cobalt oxide, lithium manganese oxide, and/or other cathode chemistries. In further embodiments, recycled materials such as black mass derived from spent lithium-ion batteries may be incorporated into the process, thereby improving sustainability and reducing reliance on high-purity virgin raw materials.

Optional post-processing steps may also be employed to refine particle properties and enhance electrochemical performance. These include ball milling with an emulsifying solvent to reduce particle size while applying a primary carbon layer, spray drying to agglomerate particles of controlled dimensions, which may include micro- or nanoscale or combinations thereof into porous secondary structures that improve tap and compact density, thermal treatments such as micro-necking to increase conductivity, and chemical vapor deposition to apply a secondary conformal coating. These steps may be performed individually or in sequence (e.g., ball milling with emulsifying solvent followed by spray drying to remove solvent and form porous secondary particles, as shown in FIGS. 5-6).

The disclosed method may produce cathode active materials with Gaussian or bimodal particle size distributions, which are particularly advantageous for advanced electrode fabrication methods, including dry-electrode processing. Such control over particle size characteristics enhances electrode packing density, mechanical interlocking, and electrical connectivity, thereby improving the overall performance of rechargeable batteries. In further embodiments, the method can generate narrowly distributed mid-micron particle sizes, wherein the mean particle size lies within the micron range and the distribution is tightly controlled around this mean, providing additional benefits for electrode uniformity and processing efficiency.

In further embodiments, the disclosed method is configured to operate as a continuous process. Such a configuration enables direct integration of powder production with slurry preparation and electrode coating, reducing intermediate handling, minimizing waste, improving throughput, and enhancing traceability across the production chain.

Accordingly, the disclosed methods provide a multifaceted, efficient, and scalable approach to manufacturing cathode active materials. The processes significantly reduce production time, enhance control over particle size and morphology, allow flexible coating strategies, support the use of recycled feedstocks, and align with next-generation continuous manufacturing practices for rechargeable batteries.

In another aspect, the present disclosure provides cathode active materials produced by the disclosed methods. The cathode materials comprise particles of controlled dimensions, which may include micro- or nanoscale or combinations thereof having controlled particle-size distributions and at least one conductive or protective coating. These engineered powders exhibit enhanced electrochemical performance when incorporated into rechargeable batteries, including improvements in conductivity, cycle stability, and energy density compared to materials produced by conventional processes.

The disclosed cathode active materials may be tailored to exhibit particle-size distributions that are narrowly Gaussian, including tightly controlled mid-micron ranges, or alternatively bimodal, depending on the requirements of electrode fabrication methods. Such control over particle morphology and distribution enhances slurry preparation, electrode coating uniformity, and dry-electrode processing performance. In certain embodiments, the resulting powders demonstrate advantageous density characteristics, such as tap densities in the range of 0.5-1.5 g/cc and compact densities in the range of 1.5-2.7 g/cc, which contribute to improved packing efficiency and electrode performance.

The cathode active materials may be applied across a broad range of chemistries, including lithium iron phosphate, lithium manganese iron phosphate, lithium nickel manganese cobalt oxide, lithium nickel cobalt aluminum oxide, lithium cobalt oxide, and lithium manganese oxide. Conductive coatings such as carbon, or other functional coatings such as oxides, polymers, or hybrid layers, may be applied to enhance surface stability and improve electronic conductivity.

In a further aspect, rechargeable batteries incorporating the disclosed cathode active materials are provided. Such batteries comprise one or more electrochemical cells in which the cathode includes the engineered powders produced by the disclosed methods. The batteries may be configured as lithium-ion cells or other secondary battery systems. By employing cathode active materials with tailored particle properties and optimized coatings, the batteries demonstrate improved performance characteristics, including higher energy density, longer cycle life, improved rate capability, and enhanced overall efficiency.

In yet another aspect, the present disclosure provides systems for manufacturing cathode active materials for rechargeable batteries. The disclosed systems are designed to enable precise control over material synthesis while supporting efficient, continuous production.

In one embodiment, the system includes a melting unit configured to process precursor raw materials into a molten mixture, and a solidification unit that, when employed, cools the melt into a dense solid ingot. In embodiments employing in-melt shear, the molten material may be directed, prior to solidification, to a shear unit (for example, a cyclone-based shear chamber) in which applied shear forces fragment the molten stream or droplets into particles having controlled size distributions. Such in-melt nanoshearing process produces particles that solidify upon cooling, enabling direct fragmentation of the molten mixture without prior solidification into an ingot. The cyclone-based chamber generates shear forces through a high-velocity vortex, as further detailed in [0049]-[0062] (FIG. 3), allowing tunable control over particle size and morphology via parameters such as shear angle and velocity. Alternatively, the molten material may be solidified into ingots for subsequent mechanical comminution. The system further comprises a coating unit configured to apply conductive or protective layers, for example carbon, oxides, or polymers, onto particulates produced by the shear or solidification pathways to enhance their electrochemical performance.

In another embodiment, the system includes an atomization unit configured to directly convert the molten mixture into fine droplets that solidify into particles of controlled dimensions, which may include micro- or nanoscale or combinations thereof. Various atomization techniques may be employed, not being limited to, including water atomization, gas atomization, induction atomization, vacuum atomization, centrifugal atomization, plasma atomization, or flame atomization. These techniques provide flexibility in tailoring particle morphology, surface characteristics, and size distribution to meet the performance requirements of different battery chemistries.

The system may further include one or more optional post-processing units, such as a ball milling unit for size refinement and primary carbon coating, a spray drying unit for agglomerating particles of controlled dimensions, which may include micro- or nanoscale or combinations thereof into porous secondary particles, a thermal-treatment unit for enhancing conductivity, and a chemical vapor deposition unit for applying secondary coatings. These modular components allow manufacturers to adapt the system configuration to suit a wide range of application needs. These units enable one or more successive processes, such as ball milling for particle size reduction, spray drying for morphology control via porous agglomeration, and thermal treatment for structural necking, in any order or combination as required.

In preferred embodiments, the system is designed for continuous operation, enabling direct integration of formation of particles of controlled dimensions, which may include micro- or nanoscale or combinations thereof, coating, and slurry preparation with electrode fabrication. Such integration minimizes handling, reduces waste, increases throughput, and improves traceability across the manufacturing chain.

Accordingly, the disclosed systems provide an industrially scalable platform for producing precision-tailored cathode active materials. By combining melt synthesis, nanoshearing or atomization, coating, and optional post-processing within a configurable and continuous workflow, the systems provide a robust solution to the growing demand for high-performance and cost-effective cathode powders in rechargeable batteries.

### BRIEF DESCRIPTION OF THE DRAWINGS

Various aspects, as well as embodiments or examples of the present disclosure, are better understood by referring to the following detailed description. To better understand the disclosure, the detailed description should be read in conjunction with the accompanying drawings.

FIG. 1 illustrates a schematic representation of a melt-shear process for manufacturing cathode active materials, including the melting of precursor materials, formation of an ingot, nanoshearing into particles of controlled dimensions, which may include micro- or nanoscale or combinations thereof, and subsequent coating and collection.

FIG. 2 illustrates a schematic representation of a melt-atomization process, in which molten material is directly atomized into fine droplets that solidify into particles of intended controlled dimensions or combinations thereof, followed by coating to form cathode active materials.

FIG. 3 illustrates a schematic representation of a cyclone-based nanoshearing process, showing the fragmentation of a solid ingot into particles of controlled dimensions, which may include micro- or nanoscale or combinations thereof with controlled size distribution through vortex-induced shear forces.

FIGS. 4A-B illustrates a schematic representation of a melt-synthesis process for producing cathode active materials, including FIG. 4A the melting of raw materials into a homogeneous molten mixture and FIG. 4B cooling or quenching to form a solid ingot suitable for further processing.

FIG. 5 illustrates an exemplary post-processing workflow following the nanoshearing route, including ball milling, spray drying, thermal treatment, and chemical vapor deposition for further tailoring of cathode powder properties.

FIG. 6 illustrates an exemplary post-processing workflow following the atomization route, including optional steps of ball milling, spray drying, thermal treatment, and chemical vapor deposition for customizing particle size, morphology, and coating properties.

### DETAILED DESCRIPTION

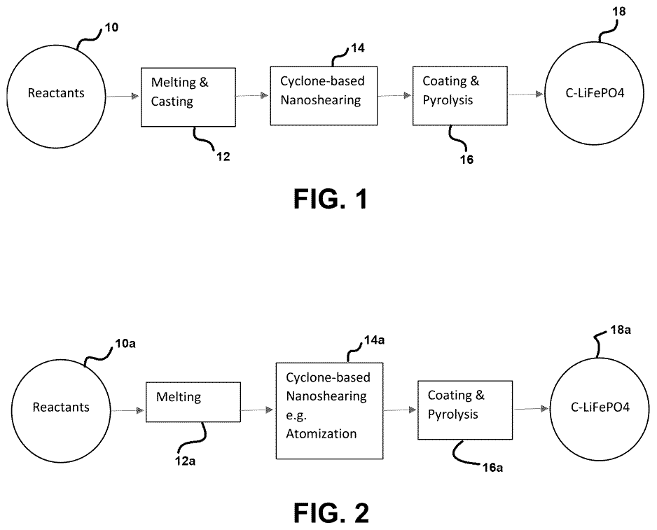

Referring to FIG. 1, the drawing schematically depicts a melt-shear route for producing precision-tailored cathode active materials. In the illustrated embodiment, precursor materials reactants 10 are melted at 12 to form a homogeneous molten slag that is cooled or cast to produce a solid feed (for example an ingot). The solid feed is then reduced to particles of controlled dimensions, which may include micro- or nanoscale or combinations thereof in a mechanical nanoshearing operation (for example a cyclone-based nanoshearing unit 14). The nanosheared particles are subsequently subjected to a coating step 16 (for example carbon deposition and/or pyrolysis) to provide a conductive surface, yielding a coated cathode material i.e. product 18, such as carbon-coated LiFePO₄.

Although FIG. 1 is exemplified using LiFePO₄, the melt-shear sequence (10→12→14→16→18) is equally applicable to other cathode chemistries and coating schemes, including but not limited to LMFP, NMC, NCA, LCO and LMO, and may be practiced using single-crystal or polycrystalline solid feeds. The segregation of melt/casting 12, controlled nanoshearing 14 and discrete coating 16 permits tighter control of particle size distribution, morphology and surface chemistry than conventional batch milling/sintering methods, enables use of lower-purity or recycled feedstocks, and supports rapid, continuous integration with downstream electrode fabrication.

In this innovative approach, the melt-shear process begins with precursor materials 10 that are introduced into a melting stage 12, where the raw materials are heated together to form a homogeneous molten slag. The molten slag is subsequently cooled or cast to produce a solid feed, such as an ingot, which may be either single-crystalline or polycrystalline in structure. The melt step 12 not only ensures uniform mixing of the constituent elements, but also facilitates the formation of a high-purity solid feed that serves as the foundation for subsequent processing. The solidified feed is then subjected to a mechanical nanoshearing operation 14, wherein the ingot is reduced into particles of controlled dimensions, which may include micro- or nanoscale or combinations thereof with a controlled and narrower particle size distribution. The nanoshearing stage 14 provides a significant advancement over conventional ball-milling techniques, which typically result in broad, less uniform particle size distributions and limited control over final powder morphology.

Following formation of particles of controlled dimensions, which may include micro- or nanoscale or combinations thereof in the nanoshearing stage 14, the particles are directed to a coating stage 16, where additional materials are introduced to deposit a conductive layer onto the particles of controlled dimensions, which may include micro- or nanoscale or combinations thereof. In one embodiment, the coating step 16 comprises the application of a carbonaceous coating to produce carbon-coated lithium iron phosphate (C—LiFePO₄) 18. The coating process at 16 is adaptable to a wide range of conductive or protective coating materials, thereby enabling optimization of conductivity, stability, and interfacial performance according to the specific requirements of different cathode chemistries.

One of the key advantages of the melt-shear route (10→12→14→16→18) is its significant reduction in energy consumption compared to conventional solid-state synthesis, which typically requires multiple stages of milling, calcination, and annealing. In particular, the melting operation 12 allows the use of precursors of lower initial purity, thereby reducing material costs and broadening the range of suitable feedstocks, including processed recycled materials. Furthermore, the nanoshearing operation 14 rapidly converts solid feed into particles of controlled dimensions, which may include micro- or nanoscale or combinations thereof with a controlled size distribution, providing a much faster production rate than traditional techniques.

The speed and efficiency of the combined melt 12 and nanoshearing 14 approach facilitate integration of material synthesis with real-time consumption in downstream electrode fabrication, thereby enabling continuous production workflows. As a result, the process of FIG. 1 not only streamlines manufacturing, but also improves overall productivity while maintaining the high quality and performance standards required for advanced cathode active materials 18.

Referring to FIG. 1, the melt-shear sequence (10→12→14→16→18) produces cathode active materials that exhibit a markedly tighter particle-size distribution and independently-tunable surface chemistry. By segregating material formation (melting/casting 12 and nanoshearing 14) from surface modification (coating 16), parameters that control particle morphology (mean size, distribution width, sphericity and primary/secondary particle architecture) can be optimized without constraining the choice, thickness or conformality of the applied coating. The powders thus obtained (18) display improved packing and slurry rheology, which promotes more uniform wet and dry coating layers on current collectors, reduces drying-related defects and delamination, and enables higher tap and compact densities in fabricated electrodes. These powder and electrode advantages translate into improved manufacturing yield, easier scale-up to continuous in-line production, and the potential for enhanced electrode performance (for example higher areal loading, improved rate capability and better cycle stability) across a range of cathode chemistries.

In one example, the method for producing cathode active materials comprises a cyclone-based nanoshearing operation 14, which converts solidified blocks of cathode precursor material, produced at the melt and cooling stage 12, into particles of controlled dimensions, which may include micro- or nanoscale or combinations thereof. The principle of the nanoshearing step 14 is analogous to the operation of a cyclone, wherein a high-velocity air vortex is generated that imparts a shearing force along its longitudinal axis. Such an airflow pattern subjects the ingot feed 10 to intense shear stresses, fragmenting the solid material into fine particles of controlled dimensions, which may include micro- or nanoscale or combinations thereof while maintaining precise control over the resulting particle-size distribution.

The ability to maintain a narrow and tunable particle-size distribution at 14 is important, as it directly influences key electrochemical properties of the resulting cathode active material, including electronic conductivity, ionic diffusivity and accessible surface area, all of which are essential for optimal battery performance. Following nanoshearing, the particles of controlled dimensions, which may include micro- or nanoscale or combinations thereof can be directed to a coating stage 16, where a conductive carbon layer or alternative functional coating is applied. Such post-formation coating step 16 enables tailored enhancements in conductivity, surface stability, and interfacial compatibility, thereby optimizing electrode performance across different battery chemistries.

By utilizing the cyclone-based nanoshearing technique 14 in combination with discrete coating at 16, the disclosed process not only accelerates production and improves process control, but also addresses persistent limitations of traditional manufacturing methods, such as high energy consumption, broad particle-size distributions, and stringent raw-material purity requirements.

The process illustrated in FIG. 1 enables the production of cathode active materials 18 having extremely narrow Gaussian particle-size distributions, which is essential for achieving consistent performance in advanced electrode fabrication. In particular, emerging techniques such as dry-electrode processing benefit substantially from this capability. Unlike conventional wet-coating methods that employ binders dissolved in solvents, dry-electrode processing utilizes specialized binders that do not require solvents to form an electrode composite on the current collector. For such processes, a controlled and reproducible particle-size distribution is essential.

The disclosed melt-shear process (reactants 10, melting/cooling 12, nanoshearing 14, coating 16, product 18) favors bimodal or otherwise tailored particle-size distributions that improve both mechanical interlocking and electrical connectivity within the electrode structure. By comparison, traditional manufacturing methods, such as ball milling and sintering, often struggle to deliver reproducible distributions due to the inherently random nature of their comminution mechanisms. Such randomness frequently results in variations in particle size and morphology, which in turn lead to suboptimal electrode packing density, non-uniform coatings, and inconsistent electrochemical performance.

By contrast, the cyclone-based nanoshearing step 14 affords precise control over particle fragmentation, yielding powders with tightly regulated size distributions and enhanced reproducibility. Such a level of control is particularly important in high-performance applications, where specific particle-size ranges are required to maximize energy density, maintain structural integrity, and improve cycle stability. Moreover, the ability to apply coatings in a distinct stage 16 after nanoshearing enables additional tailoring of particle properties without compromising distribution control.

Accordingly, the disclosed process not only provides cathode active materials 18 optimized for solvent-free electrode fabrication, but also broadens design flexibility for next-generation cells by enabling reproducible, distribution-tailored powders that improve overall battery efficiency and performance.

Referring to FIG. 2, in one embodiment of the disclosed method, precursor reactants 10a are introduced and melted at elevated temperatures in a melting stage 12a to form a homogeneous molten slag. The molten material is then directly fed into a nanoshearing unit, such as an atomizer 14a, where it is converted into particles of controlled dimensions, which may include micro- or nanoscale or combinations thereof. Following formation of particles of controlled dimensions, which may include micro- or nanoscale or combinations thereof at 14a, the powders are directed to a coating stage 16a, in which additional materials are introduced to apply a conductive layer, for example a carbon coating. The coated particles obtained at 16a constitute the final cathode active material 18a, exemplified here as carbon-coated lithium iron phosphate (C—LiFePO₄).

The atomizer 14a is a specialized device configured to transform molten slag into fine droplets by forcing the melt through a nozzle or orifice and subjecting it to a high-velocity stream of a cutting fluid or gas. The droplets produced in this step rapidly cool and solidify into particles of controlled dimensions. Atomization of molten feedstocks is a technique broadly employed in powder metallurgy, where it is valued for its ability to directly convert molten metals into finely divided powders. In the context of the present disclosure, the atomization step 14a allows for the immediate transformation of molten precursor material into particles of controlled dimensions, thereby eliminating intermediate solidification and comminution steps and streamlining the overall production process.

A variety of atomization techniques may be utilized for the nanoshearing stage 14a, including but not limited to water atomization, gas atomization, induction atomization, vacuum atomization, centrifugal atomization, plasma atomization, and flame atomization. Each of these methods provides distinct advantages in terms of throughput, cooling rate, particle morphology, and achievable size distribution. Accordingly, the selection of atomization method at 14a may be tailored to the specific cathode chemistry, coating requirements, and application performance objectives.

In the atomization nanoshearing stage 14a, a variety of cutting fluids or atomizing media may be employed, each imparting distinct properties that influence particle morphology, size distribution, and surface characteristics. For example, water atomization can yield generally spherical particles with relatively uniform size distributions, while gas atomization may produce finer particles with more controlled morphologies. Induction and vacuum atomization techniques enable precise regulation of melt temperature at the melting stage 12a and during atomization at 14a, which is important for achieving targeted particle characteristics and avoiding undesired segregation or inhomogeneity. Centrifugal and plasma atomization methods generate high-velocity jets that promote rapid quenching of the molten droplets, resulting in refined particle-size distributions and improved material properties. Flame atomization and related methods may further be employed where enhanced control of cooling rates or surface chemistry is required.

The ability to select from multiple atomization techniques at 14a provides significant flexibility in tailoring cathode active materials to meet diverse performance requirements. By integrating the melting step 12a with immediate atomization at 14a, the disclosed process establishes a continuous and efficient workflow that minimizes intermediate handling, reduces processing time, and maximizes control over particle formation. The resulting powders, when subsequently coated at 16a to yield final product 18a, exhibit improved uniformity, enhanced electrochemical properties, and better consistency across production runs. The integrated melt-atomization approach therefore not only advances cathode powder performance but also supports industry trends toward continuous, high-throughput manufacturing processes with improved reproducibility and quality control.

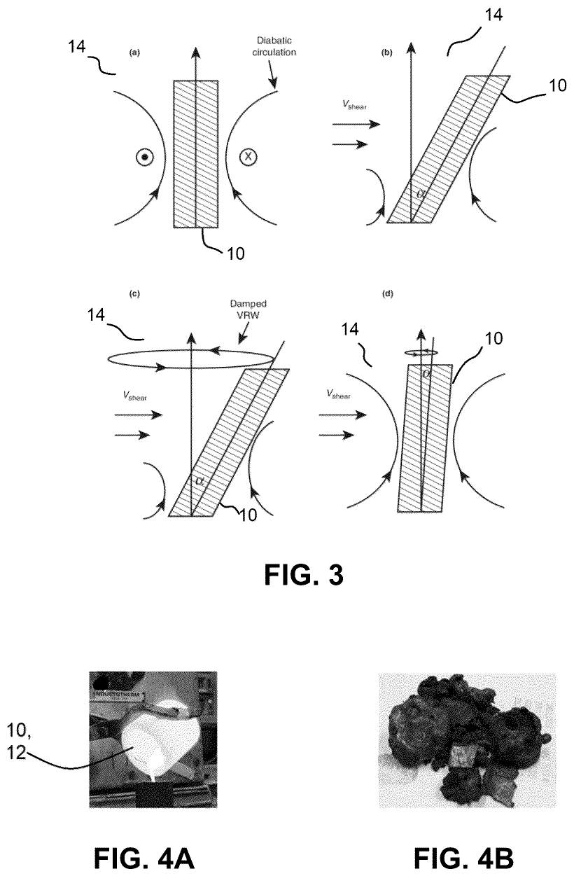

Referring to FIG. 3, there is illustrated a schematic of the disclosed cyclone nanoshearing process for manufacturing secondary battery positive electrode (cathode) materials with precision-tailored powder properties. In the illustrated embodiment, a solid feed or ingot 10 is introduced into a cyclone nanoshearing unit 14, where it is subjected to intense shear forces generated by a high-velocity vortex. The resulting nanosheared particles are then conveyed to a coating stage 16 and converted into a finished cathode active product 18.

The cyclone-based nanoshearing technique has historically found use in fields such as aerospace for producing specialty coatings, where exacting powder properties are required to meet demanding operating conditions. However, this technique has not previously been applied to the production of cathode active materials, despite the fact that battery applications impose multiple performance constraints, including the need for powders with controlled size distributions, enhanced processability, and improved electrochemical functionality. By adapting cyclone nanoshearing to cathode material production, the present disclosure provides a route to powders with finely tuned particle characteristics that directly improve mixing, coating, and electrochemical performance during battery cell fabrication.

As shown schematically in FIG. 3, the cyclone operates by generating a high-velocity air vortex, which imparts controlled shear forces on the ingot feed 10, fragmenting it into particles of controlled dimensions, which may include micro- or nanoscale or combinations thereof with a narrow particle-size distribution. Such high level of precision in particle formation is important in battery applications, where particle size and morphology strongly influence electrode packing density, electronic conductivity, ionic transport, and overall electrochemical stability.

The cyclone nanoshearing stage 14 also provides a range of tunable control parameters that enable tailoring of powder properties for specific applications. Key parameters include the shear angle (α), the shear velocity (V_shear), and the behavior of damped vortex Rossby waves (VRW) within the cyclone chamber. Each of these factors influences the dynamics of the shearing process and the resulting particle characteristics. For example, adjusting the shear angle (α) modifies the interaction between the ingot and the airflow, thereby influencing fragmentation intensity and particle size. Similarly, varying the shear velocity (V_shear) regulates the energy imparted to the material: higher velocities produce finer particles of controlled dimensions, which may include micro- or nanoscale or combinations thereof, while lower velocities yield coarser distributions. The presence and control of VRW further refine flow behavior, particle collisions, and uniformity of size distribution.

By customizing these parameters, the nanoshearing stage 14 enables precise engineering of cathode active powders with targeted size distributions, surface areas, and morphologies. When followed by coating at 16, the process produces cathode active material 18 optimized for enhanced conductivity, stability, and performance. Accordingly, application of the cyclone-based nanoshearing technique to battery materials not only overcomes the limitations of conventional milling and grinding processes, but also establishes a new benchmark in reproducibility, scalability, and quality for electrode material production.

Referring to FIGS. 4A-B, the process for manufacturing precision-tailored cathode active materials begins with the formation of solid feed blocks suitable for subsequent nanoshearing. In the illustrated embodiment, a melt-synthesis route is employed. As shown in FIG. 4A, precursor reactants 10 are introduced into a melting stage 12 where the raw materials are heated together to form a homogeneous molten slag. The molten material is then cooled or quenched, for example under an inert atmosphere such as nitrogen blanket, to produce a dense solid feedstock, such as an ingot, as depicted in FIG. 4B. The ingot may be single-crystalline or polycrystalline in structure and serves as the input material for downstream cyclone nanoshearing 14 and coating 16 operations.

The melt-synthesis method illustrated in FIGS. 4A-B provides several advantages compared to conventional solid-state synthesis or chemical precipitation routes. Because the precursors are fully melted and homogenized at 12, the resulting ingots exhibit uniform chemical composition, which improves reproducibility in subsequent processing. In addition, melt synthesis reduces the number of intermediate steps, minimizes process waste, and permits the use of lower-cost or less-refined precursors, including recycled or environmentally friendly feedstocks. These advantages translate into reduced production costs, higher process efficiency, and improved control over the composition and powder properties of the final cathode active material 18.

One advantage of the melt-synthesis route exemplified in FIGS. 4A-B is its ability to accommodate lower-grade or recycled precursors. In one embodiment, precursor materials 10 including, for example, processed black mass from battery recycling streams, may be introduced into the melting stage 12 without the stringent purity requirements typical of conventional solid-state syntheses. The melting operation 12 promotes homogenization of the component elements and facilitates the segregation or removal of certain impurities from the desired melt, thereby reducing downstream purification burdens and lowering raw-material costs.

Because the melt at 12 is fully liquified and mixed, a controlled cooling or quench step yields a dense, uniform solid feed (ingot) suitable for subsequent comminution. The controlled solidification of the molten slag produces a block having consistent composition and structural homogeneity, which is beneficial for reproducible downstream processing. In one example, the cooling/solidification may be performed in an inert or controlled atmosphere to preserve desired stoichiometry and to limit oxidation or volatilization of sensitive components.

The resulting solid feed (ingot) produced by the melt/solidification sequence at 12 serves as the input for the mechanical nanoshearing operation 14. Because the ingot formed at 12 is compositionally uniform and mechanically robust, the nanoshearing step 14 can more readily produce particles of controlled dimensions, which may include micro- or nanoscale or combinations thereof having narrowly controlled size distributions, high sphericity and reproducible morphology. Such precisely tailored particles of controlled dimensions, which may include micro- or nanoscale are then amenable to subsequent surface modification (for example coating 16) and to formulation into cathode slurries and electrodes 18 with predictable packing, rheology and electrochemical performance.

Accordingly, the melt synthesis (10→12→ingot→14→16→18) provides a cost-effective, scalable route to high-quality cathode active materials by enabling the use of lower-cost feedstocks, reducing intermediate processing, and improving the reproducibility of downstream particle engineering steps.

In the melt-synthesis method for producing cathode active materials, a systematic approach is employed to transform various raw precursors into a solid ingot suitable for downstream nanoshearing and coating. As illustrated in FIG. 4A, precursor materials 10 are introduced into a melting stage 12 in a suitable vessel, such as a graphite crucible, and subjected to elevated temperatures, for example exceeding 1000° C. At these conditions, the raw materials melt and react to form the desired cathode composition. Upon cooling or quenching, the molten mixture solidifies to yield a dense ingot as shown in FIG. 4B, which serves as the feedstock for subsequent nanoshearing 14 and coating 16 operations to produce the final cathode active material 18.

In the case of lithium iron phosphate (LiFePO₄), the raw material feed may comprise, for example and without limitation, lithium dihydrogen phosphate (LiH₂PO₄), iron oxide (Fe₂O₃), and metallic iron (Fe). Alternative lithium sources such as lithium carbonate (Li₂CO₃) or lithium hydroxide (LiOH), and alternative phosphate sources such as phosphoric acid (H₃PO₄), solid phosphorus, iron phosphate (FePO₄), ammonium phosphate ((NH₄)₃PO₄), diammonium phosphate ((NH₄)₂HPO₄), or monoammonium phosphate ((NH₄)H₂PO₄) may also be employed. These feedstocks undergo reaction upon melting at 12 to form the target LiFePO₄ phase. The cooling step may be performed under ambient or inert atmosphere, depending on the desired phase purity and final material properties.

As demonstrated in FIGS. 4A-B, the melt-synthesis process is also compatible with recycled materials, such as processed black mass from lithium-ion battery recycling in which transition metals like nickel and cobalt have been removed. Integration of such recycled precursors not only enhances sustainability but also reduces reliance on virgin raw materials. Moreover, the robust nature of the melt-synthesis stage 12 allows the use of lower-grade precursors than those typically required for conventional solid-state synthesis of battery-grade materials, thereby lowering costs and improving resource efficiency. The resulting solid ingot exhibits uniform composition and structural integrity, which are important for consistent particle formation during nanoshearing 14 and coating 16 to yield reproducible, high-performance cathode active material 18.

Referring to FIG. 4B, the solid ingots produced through the melt-synthesis stage 12 may be cast or molded into selected geometries to facilitate efficient downstream nanoshearing 14. In one embodiment, the ingots are formed as cylindrical blocks, which are particularly well suited for continuous feeding into a cyclone-based nanoshearing unit 14. Shaping the ingots in this manner enhances the ease of handling, improves process efficiency, and contributes to the reproducibility of formation of particles of controlled dimensions, which may include micro- or nanoscale or combinations thereof.

When properly optimized, the ingots formed at 12 exhibit high chemical uniformity and consist essentially of the target cathode active material, with substantially reduced levels of impurities that are commonly encountered in conventional solid-state or precipitation syntheses. The homogeneous nature of these ingots ensures that the subsequent nanoshearing operation 14 produces particles of controlled dimensions, which may include micro- or nanoscale having uniform composition and morphology. By controlling both the ingot geometry and compositional purity, the melt-synthesis process thus provides a robust foundation for generating coated cathode active powders 18 with highly reproducible particle-size distributions and electrochemical properties.

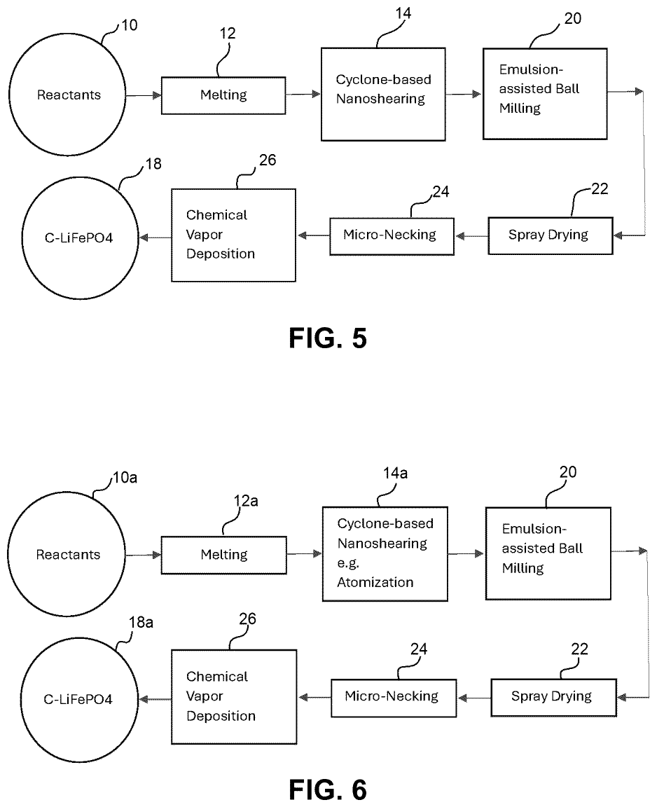

Referring to FIG. 5, certain post-processing steps may be combined with the melt+nano-shear route to provide additional control over particle morphology, porosity, electrical conductivity and bulk packing density. In one embodiment, the particulate output of the nanoshearing unit 14 is collected and fed to an emulsion-assisted ball-milling stage 20. In the emulsion-assisted ball-milling stage 20, the powders are milled in the presence of an emulsifying solvent that encapsulates individual particles during milling. The encapsulation reduces mechanical damage to particle sphericity, controls agglomeration, and enables the controlled reduction of primary particle size. A carbonaceous precursor may be introduced in the emulsifying medium during stage 20 so as to form a primary (intra-particle or conformal) carbon layer on the particles during or immediately after milling.

Following milling 20, the milled powders can be subjected to spray drying 22 to form larger, porous secondary agglomerates. The spray-dried secondary particles produced at 22 exhibit a controlled porous structure that improves packing efficiency and tap/compact density while maintaining pore pathways for electrolyte wetting. The porous secondary morphology produced at 22 is particularly useful for increasing compact density without a disproportionate increase in specific surface area.

Thereafter, the spray-dried agglomerates may be thermally treated in a micro-necking step 24. In one example, micro-necking 24 is carried out at about 600-650° C. for about 20-30 minutes; this thermal treatment promotes neck formation between primary particles, carbonizes organic precursors where present, and increases electronic percolation within the secondary particles. The micro-necking step 24 is performed under an appropriate controlled atmosphere (for example an inert atmosphere) as required by the selected chemistry and desired surface characteristics.

After micro-necking 24, the particles may receive a secondary, conformal surface coating using chemical vapor deposition (CVD) 26, or other suitable vapor-phase or solution coating techniques. The CVD step 26 enables deposition of a uniform outer carbon layer and/or other functional coatings that further enhance electronic conductivity, surface stability and cycle life of the cathode active material.

Following the foregoing sequence (milling 20→spray drying 22→micro-necking 24→CVD 26), the powders are subjected to final classification/sizing and quality control (removal of fines, sieving, particle-size classification) and are then packaged as the finished cathode active material i.e. product 18 for shipment. The order, presence or parameters of any individual post-processing step are optional and may be adjusted to meet application-specific requirements; for example, one or more of steps 20, 22, 24 or 26 may be omitted, repeated, or performed in a different sequence.

By employing the optional post-processing sequence illustrated in FIG. 5, powders having improved bulk properties can be obtained. In particular, the process can produce cathode powders having increased tap density (for example about 0.5-1.5 g/cc) and increased compact density (for example about 1.5-2.7 g/cc), together with improved slurry behavior and enhanced electrochemical performance in electrodes.

Referring to FIG. 6, additional post-processing steps may be combined with the melt-atomization route to provide enhanced control over particle morphology, porosity, electrical conductivity and bulk packing properties. In one embodiment, molten reactants 10a are melted at 12a and converted to powder or droplets in an atomizer or other atomization nanoshearing unit 14a. Atomization may be effected using any suitable atomization technique (for example, water atomization, gas atomization, induction atomization, vacuum atomization, centrifugal atomization, plasma atomization, flame atomization, or the like) and using an appropriate cutting fluid or gas as required by the selected technique.

The particulate output from the atomization/nanoshearing unit 14a can be fed to an emulsion-assisted ball-milling stage 20. In stage 20, the powders are milled in the presence of an emulsifying medium that encapsulates individual particles during milling. Encapsulation during the emulsion-assisted milling reduces mechanical damage to particle sphericity, controls primary particle size reduction, and limits undesired agglomeration. A carbonaceous precursor may be added to the emulsifying medium or introduced concurrently during milling 20 so as to form a primary carbon layer on the milled particles either in-situ or in a subsequent short thermal step.

Following emulsion-assisted milling 20, the milled powders can be subjected to spray drying 22 to produce controlled secondary agglomerates. The spray-dried secondary particles formed at 22 exhibit a tailored porous architecture that improves packing efficiency and electrolyte access while maintaining a relatively low overall specific surface area. This porous secondary morphology produced at 22 advantageously increases tap and compact densities compared with non-agglomerated powders, while preserving electrolyte wetting characteristics.

The spray-dried agglomerates may then be thermally treated in a micro-necking step 24 to promote neck formation between primary particles, to carbonize any organic precursor introduced earlier, and to enhance electronic percolation within the secondary particle. In one example, micro-necking 24 is carried out at about 600-650° C. for about 20-30 minutes in an appropriate controlled atmosphere (for example an inert atmosphere such as N₂ or Ar, or a reducing atmosphere as required by the chemistry) to achieve the desired conductivity and structural consolidation.

After micro-necking 24, the particles may receive a secondary, conformal surface coating using chemical vapor deposition (CVD) 26 or other suitable vapor-phase or solution coating techniques. The CVD stage 26 enables deposition of a uniform outer carbon layer and/or other functional coatings (for example conductive oxides, protective metal oxides, doped carbon, or ceramic layers) that further improve electronic conductivity, surface stability and cycle life of the cathode active material.

Following the sequence of emulsion-assisted ball milling 20→spray drying 22→micro-necking 24→CVD 26, the powders are subjected to final classification and quality control (for example sieving, air classification, removal of oversize/undersize fractions, and impurity screening), after which the finished cathode active material 18a is packaged (for example in air-tight bags or supersacks) for shipment. Any of the foregoing steps 20, 22, 24, 26 may be omitted, repeated, or carried out in a different order depending on the desired particle attributes and application requirements; for example, a primary carbon layer introduced at 20 may reduce the processing required at 26, or CVD 26 may be omitted where a solution coating provides the necessary surface chemistry.

By employing the optional post-processing sequence illustrated in FIG. 6, cathode powders having improved bulk properties can be obtained. In particular, the process can produce powders having increased tap density (for example about 0.5-1.5 g/cc) and increased compact density (for example about 1.5-2.7 g/cc), together with improved slurry rheology and enhanced electrochemical performance when formulated into electrodes.

As illustrated in FIGS. 1-3, following the nanoshearing step 14, 14a in which the solid ingot 10 or molten feed 10a is converted into particles of controlled dimensions with a controlled size distribution, the powders may be directed to an optional coating stage 16, 16a. The capability to apply such a coating is particularly significant for cathode chemistries such as lithium iron phosphate (LiFePO₄) and lithium manganese iron phosphate (Li[Mn, Fe]PO₄), which exhibit relatively low intrinsic electronic conductivity. In such cases, the application of a carbon coating at 16 or 16a is essential to improve conductivity and enable the realization of practical specific capacities during electrochemical cycling.

A principal advantage of the disclosed process (10→12→14→16→18; 10a→12a→14a→16a→18a) is the deliberate segregation of particle formation from the coating stage. By decoupling nanoshearing 14, 14a from coating 16, 16a, the method provides greater flexibility in tailoring surface properties than conventional synthesis techniques where coating is inseparably integrated into material formation. By decoupling particle formation from coating, the disclosed method allows for coatings to be tailored to specific application requirements, whether to enhance conductivity, stability, cycle life, or interfacial compatibility. Such modularity permits a wide variety of coatings including carbon, oxides, doped carbons, or hybrid coatings to be applied as required by the target battery chemistry and performance objectives.

The modularity of this approach not only improves the adaptability of the resulting cathode active material 18, 18a but also allows manufacturers to adapt formulations to evolving battery technologies and end-use applications. As a result, the separation of nanoshearing 14, 14a and coating 16, 16a contributes to improved performance characteristics, greater adaptability, and the scalable production of high-quality cathode active materials for advanced energy-storage systems. The resulting cathode active material 18, 18a therefore combines tightly controlled particle-size distributions with tailored surface modifications, leading to improved electrode processability, enhanced electrochemical performance, and greater adaptability to evolving energy-storage technologies.

The disclosed method for producing cathode active materials is designed to support in-situ production and to enable a continuous manufacturing process that integrates material synthesis, slurry preparation, and electrode coating in a streamlined sequence. In conventional practice, cathode powders are typically manufactured in separate facilities, packaged in supersacks, bags, or other containers, and later transported to cell-manufacturing plants. At the point of use, the powders are mixed in discrete batches to form a slurry, which is subsequently fed into coating lines. Such batch-based workflows introduce inefficiencies, including time delays between production and consumption, increased handling and logistics costs, and challenges in maintaining traceability and process consistency.

In contrast, the disclosed approach provides for the rapid production of cathode active powders (for example through the melt-shear or melt-atomization sequences illustrated in FIGS. 1-2) with sufficiently short cycle times to enable direct, real-time integration with slurry mixing and electrode coating operations. By synchronizing powder formation, optional coating 16, 16a, and immediate downstream slurry preparation, the process aligns production rates with consumption rates, minimizes intermediate storage, and reduces material waste.

Adopting a continuous, in-line process also enhances process control and traceability. For example, coated electrodes produced from continuously supplied slurry may be provided with machine-readable identifiers or other markings that allow end-to-end tracking of manufacturing history, quality, and compliance parameters. This level of traceability is difficult to achieve with conventional batch methods but is increasingly important as cell manufacturers scale to higher throughputs and stricter quality standards.

Accordingly, the disclosed continuous-production method not only improves throughput and operational efficiency but also enhances consistency in cathode powder properties, electrode performance, and overall quality assurance across the battery manufacturing value chain.

It is to be noted that, in contrast to conventional processes for manufacturing cathode materials such as solid-state synthesis the disclosed method employs a melt-synthesis stage 12, 12a followed by nanoshearing 14 or atomization 14a, resulting in substantial reductions in overall production time. In one embodiment, the melt-synthesis step 12, 12a requires approximately 1-2 hours to produce a homogeneous ingot or molten feedstock. The subsequent nanoshearing or atomization stage 14, 14a is highly efficient, requiring only about 5-10 minutes to convert the solid or molten precursor into fine particles of controlled dimensions, which may include micro- or nanoscale or combinations thereof with a tightly controlled particle-size distribution.

The above stated accelerated timeline not only enables the rapid production of materials with low intrinsic conductivity, such as LiFePO₄, but also facilitates streamlined integration with subsequent coating 16, 16a and optional post-processing steps (20-26, FIGS. 5-6). By reducing the duration and scale of each stage, the disclosed method supports a continuous flow of material from synthesis to application, in contrast to batch-based methods that rely on lengthy calcination or milling. Where calcination is employed, its footprint and duration can be significantly reduced, as the nanoshearing or atomization stage delivers powders in smaller, uniform, and more readily processed batches.

Accordingly, the disclosed process (10→12→14/14a→16/16a→18/18a) represents a significant advancement in cathode-material production by minimizing processing time, improving efficiency, and enabling integration with continuous electrode manufacturing. The resulting cathode active powders not only exhibit improved electrochemical properties but also provide a scalable pathway to high-performance energy storage solutions capable of meeting the increasing demands of modern applications.

As used herein, the term “cell” refers to an electrochemical cell, which constitutes the smallest packaged unit capable of converting chemical energy into electrical energy. Unless otherwise indicated, the term “battery” refers to an assembly comprising one or more such cells, for example a stack or module of interconnected cells configured to operate together.

The foregoing description sets forth example embodiments of the present disclosure and is not intended to limit the scope of protection. It will be understood by those of ordinary skill in the art that various modifications, substitutions, and equivalents may be employed without departing from the spirit and scope of the invention. Substantially equivalent structures, methods, or process steps that achieve the same or comparable results, whether in the same or a different manner, are intended to fall within the scope of the present disclosure. Accordingly, the exemplary embodiments described herein should not be construed as limiting, but rather as illustrative of the broader concepts encompassed by the claims. Furthermore, the present concepts expressly include any and all combinations and sub-combinations of the features and elements described above. Unless expressly defined otherwise herein, words and phrases used in this disclosure are to be accorded their ordinary and customary meaning as understood by those skilled in the relevant art.

Further, the invention is not limited to the precise constructions, materials, or compositions described herein, and all such modifications, substitutions, changes, and variations that become apparent from the foregoing description are intended to be encompassed within the spirit and scope of the disclosure as defined by the appended claims.

1. A method of manufacturing a cathode active material for a rechargeable battery, comprising:
melting precursor materials to form a molten mixture;
processing the molten mixture by nanoshearing to produce particles, that solidify upon cooling or atomizing the molten mixture into fine droplets that solidify into particles; and
applying a conductive or protective coating to the particles, wherein the cathode active material exhibits a controlled particle size distribution tailored for use in secondary batteries.

2. The method of claim 1, wherein the nanoshearing comprises subjecting the molten mixture to cyclone-based nanoshearing that generates shear forces through a high-velocity vortex to fragment the molten mixture into particles that solidify upon cooling.

3. The method of claim 1, wherein the atomizing comprises one or more processes including, but not limited to, water atomization, gas atomization, induction atomization, vacuum atomization, centrifugal atomization, plasma atomization, and flame atomization, and combinations thereof.

4. The method of claim 1, wherein the coating comprises carbon coating, metal oxide coating, polymer coating, or combinations thereof.

5. The method of claim 1, wherein the precursor materials include lithium, transition metal, and phosphate sources suitable for forming lithium iron phosphate, lithium manganese iron phosphate, lithium nickel manganese cobalt oxide, lithium nickel cobalt aluminum oxide, lithium cobalt oxide, or lithium manganese oxide or other materials used as battery cathodes.

6. The method of claim 1, further comprising employing recycled battery materials, including processed black mass, as at least part of the precursor materials.

7. The method of claim 1, further comprising an optional post-processing step selected from the group consisting of:
ball milling with an emulsifying solvent to refine particle size and apply a primary carbon layer subsequently used as an input feed for spray drying to remove any solvent, and convert to porous secondary particles,
thermal treatment to increase conductivity, and
chemical vapor deposition to apply a secondary conformal coating.

8. The method of claim 1, wherein the resulting cathode active material exhibits a bimodal or Gaussian particle size distribution including tightly controlled mid-micron ranges and particle morphology.

9. The method of claim 1, wherein the method is performed in a continuous process that integrates powder production with slurry preparation and electrode coating.

10. The method of claim 1, wherein processing the molten mixture comprises solidifying the molten mixture into a solid ingot and comminuting the solid ingot into particles via one or more mechanical processes including but not limited to grinding, milling, nanoshearing, or combinations thereof.

11. The method of claim 1, wherein processing the molten mixture comprises either (i) directly solidifying the molten mixture into a solid ingot for subsequent comminution or (ii) directly nanoshearing the molten mixture to produce particles that solidify upon cooling.

12. A cathode active material produced by the method of claim 1, wherein the material comprises particles of controlled dimensions and morphology with a tailored particle size distribution and a conductive coating that enhances electrochemical performance in a rechargeable battery.

13. The cathode active material of claim 12, wherein the material exhibits a tap density in the range of 0.5-1.5 g/cc and a compact density in the range of 1.5-2.7 g/cc.

14. A rechargeable battery comprising at least one electrochemical cell including a cathode fabricated from the cathode active material of claim 12.

15. The rechargeable battery of claim 14, wherein the electrochemical cell is configured as a lithium-ion cell.

16. A system for manufacturing a cathode active material for a rechargeable battery, comprising:
a melting unit configured to melt precursor materials into a molten mixture;
a nanoshearing unit configured to fragment the molten mixture into particles that solidify upon cooling; and
a coating unit configured to apply a conductive or protective coating to the particles.

17. The system of claim 16, wherein the nanoshearing unit comprises a cyclone nanoshearing chamber that generates shear forces through a high-velocity air vortex.

18. The system of claim 16, further comprising an atomization unit configured to directly atomize the molten mixture into droplets that solidify into particles of controlled dimensions and morphology.

19. The system of claim 16, further comprising a post-processing unit configured to perform at least one process selected from ball milling, spray drying, thermal treatment, and chemical vapor deposition.

20. The system of claim 16, wherein the system is configured for continuous operation such that particle formation and coating are integrated with slurry preparation and electrode coating steps.

21. The system of claim 16, further comprising a post-processing unit configured to subject the particles to one or more successive processes for changing particle size dimensions and controlling particle morphology, the successive processes including but not limited to ball milling, spray drying, and thermal treatment.
